(19) United States
(12) Patent Application Publication
(10) Pub. No.: US 2023/0120388 A1
(43) Pub. Date: Apr. 20, 2023

(54) ANTIBACTERIAL FILM, TOUCH PANEL, AND MANUFACTURING METHOD FOR ANTIBACTERIAL FILM

(71) Applicant: FUJIFILM Corporation, Tokyo (JP)

(72) Inventors: Shinsuke MOROMIZATO, Shizuoka (JP); Takahiro NAKAZAWA, Shizuoka (JP); Masayuki KURAMITSU, Shizuoka (JP)

(73) Assignee: FUJIFILM Corporation, Tokyo (JP)

(21) Appl. No.: 18/066,264

(22) Filed: Dec. 14, 2022

Related U.S. Application Data
(63) Continuation of application No. PCT/JP2021/023209, filed on Jun. 18, 2021.

(30) Foreign Application Priority Data
Jun. 19, 2020 (JP) 2020-106509
Mar. 3, 2021 (JP) 2021-033424
May 11, 2021 (JP) 2021-080432

(51) Int. Cl. A01N 25/34; A01N 59/16; C08J 7/04; C09D 5/14; C09D 7/62; C09D 7/65; C09D 135/02; G02B 1/18

(52) U.S. Cl. CPC A01N 25/34; A01N 59/16; C08J 7/0427; C09D 5/14; C09D 7/62; C09D 7/65; C09D 135/02; G02B 1/18; C08J 2367/02; C08J 2435/02; G06F 3/041

(57) ABSTRACT

An object of the present invention is to provide an antibacterial film having an antiglare function and excellent image visibility, a touch panel, and a manufacturing method for an antibacterial film.

An antibacterial film of the present invention contains a base material and at least one antibacterial layer disposed on the base material, in which the antibacterial layer contains a binder, a light diffusing particle, and an antibacterial agent particle and satisfies a specific condition 1.

### CROSS-REFERENCE TO RELATED APPLICATIONS

This application is a Continuation of PCT International Application No. PCT/JP2021/023209 filed on Jun. 18, 2021, which claims priority under 35 U.S.C. § 119(a) to Japanese Patent Application No. 2020-106509 filed on Jun. 19, 2020, Japanese Patent Application No. 2021-033424 filed on Mar. 3, 2021 and Japanese Patent Application No. 2021-080432 filed on May 11, 2021. The above applications are hereby expressly incorporated by reference, in its entirety, into the present application.

### BACKGROUND OF THE INVENTION

### 1. Field of the Invention

The present invention relates to an antibacterial film, a touch panel, and a manufacturing method for an antibacterial film.

### 2. Description of the Related Art

From the viewpoint of surface protection, a protective film and/or a scattering prevention film is used for a touch panel of a liquid crystal display, an organic EL display, or the like. Since the touch panel that is used in a mobile device such as a game machine or a cellular phone is frequently used, there are many opportunities for bacteria to adhere to the touch panel. In addition, a touch panel-attached display device equipped in a ticket vending machine at a station, an automatic teller machine (ATM) at a bank, a medical device in a medical facility, an ordering device at a restaurant, or the like, is used by an unspecified large number of people, and thus there is a high possibility that various bacteria adhere to it in the use environment. As a result, from the viewpoint of suppressing the growth of bacteria and reducing the risk of infection with a disease, there has been proposed a technique of providing a film or sheet (hereinafter, both are collectively referred to as an antibacterial film) having antibacterial properties on the surface of a touch panel.

For example, JP2016-185686A discloses a base material attached with an antibacterial layer, including a base material having optical anisotropy and an antibacterial layer disposed on at least a part of a surface of the base material, where the antibacterial layer contains an antibacterial agent fine particle having a specific average particle diameter and a binder, the thickness of the antibacterial layer is more than 5 μm and 15 μm or less, and the tensile strength of the base material is 200 MPa or more.

### SUMMARY OF THE INVENTION

As a result of further studying an antibacterial film having an antiglare function based on the technology disclosed in JP2016-185686A or the like, the inventors of the present invention found that there is room for further improvement in the image visibility of such an antibacterial film.

In consideration of the above circumstances, an object of the present invention is to provide an antibacterial film having an antiglare function and excellent image visibility. Another object of the present invention is to provide a touch panel and a manufacturing method for an antibacterial film.

As a result of carrying out intensive studies to achieve the above-described object, the inventors of the present invention have found that the above-described object can be achieved by the following configurations.

[1] An antibacterial film comprising:

a base material; and

at least one antibacterial layer disposed on the base material,

in which the antibacterial layer contains a binder, a light diffusing particle, and an antibacterial agent particle, and

the antibacterial film satisfies the condition 1 described later.

[2] The antibacterial film according to [1], in which the antibacterial film further satisfies the condition 2 described later.

[3] The antibacterial film according to [1] or [2], in which an arithmetic average roughness Ra of a surface of the antibacterial layer is 0.1 to 10 μm.

[4] The antibacterial film according to any one of [1] to [3], in which the average value Hc of the hazes of the antibacterial film in the wavelength range of 380 to 750 nm is 20% or more.

[5] The antibacterial film according to any one of [1] to [4], in which the light diffusing particle is an acrylic resin particle.

[6] The antibacterial film according to any one of [1] to [5], in which a content of the light diffusing particle is 1% to 15% by mass with respect to a total mass of the antibacterial layer.

[7] The antibacterial film according to any one of [1] to [6], in which the antibacterial agent particle contains silver.

[8] The antibacterial film according to any one of [1] to [7], in which the antibacterial agent particle contains a silver supporting carrier.

[9] The antibacterial film according to any one of [1] to [8], in which a content of the antibacterial agent particle is 0.1% to 20% by mass with respect to a total mass of the antibacterial layer.

[10] The antibacterial film according to any one of [1] to [9], in which a thickness of the antibacterial layer is 0.01 to 10 μm.

[11] The antibacterial film according to any one of [1] to [10], in which a material constituting the base material is at least one selected from the group consisting of polyethylene terephthalate, triacetyl cellulose, and polycarbonate.

[12] The antibacterial film according to any one of [1] to [11], in which an arithmetic average roughness Ra and a maximum height Rz of a surface of the base material satisfy both Expression (a1) and Expression (b1).

[13] The antibacterial film according to any one of [1] to [12], in which the antibacterial layer is disposed on one surface of the base material, and a pressure-sensitive adhesive layer is disposed on a surface of the base material opposite to the surface on which the antibacterial film is disposed.

[14] A touch panel comprising the antibacterial film according to any one of [1] to [13].

[15] A manufacturing method for the antibacterial film according to any one of [1] to [13], the manufacturing method comprising:

a step of applying a composition for forming an antibacterial layer, containing an antibacterial agent particle, a binder, and a light diffusing particle, onto a base material to form a coating film;

a step of heating the coating film at 20° C. to 60° C.; and

a step of curing the coating film to form an antibacterial layer by irradiating the coating film with an ultraviolet ray at an output of 190 mJ/cm² or more.

According to the present invention, it is possible to provide an antibacterial film having an antiglare function and excellent image visibility.

In addition, according to the present invention, it is possible to provide a touch panel and a manufacturing method for an antibacterial film.

### BRIEF DESCRIPTION OF THE DRAWINGS

FIG. 1 is a cross-sectional view illustrating an example of an antibacterial film according to the present invention.

### DESCRIPTION OF THE PREFERRED EMBODIMENTS

Hereinafter, the present invention will be described in detail.

The explanation of the constituent elements described below may be based on representative embodiments of the present invention; however, the present invention is not intended to be limited to those embodiments.

In the present specification, the numerical value range indicated by using “to” means a range including the numerical values before and after “to” as the lower limit value and the upper limit value, respectively. In the range of numerical value disclosed stepwise in the present specification, an upper limit value or a lower limit value disclosed in a certain range of numerical values may be replaced with an upper limit value or a lower limit value disclosed in another range of numerical values disclosed in stepwise. In addition, in the range of numerical values disclosed in the present specification, an upper limit value or a lower limit value disclosed in a certain range of numerical values may be replaced with values shown in examples.

In the present specification, in a case where there are a plurality of substances corresponding to each component in the composition, the amount of each component in the composition means the total amount of the plurality of substances present in the composition unless otherwise specified.

In the present specification, the term “step” includes not only an independent step but also a step that cannot be clearly distinguished from other steps, as long as the intended purpose of the step is achieved.

In the present specification, “% by mass” and “% by weight” are synonymous, and “parts by mass” and “parts by weight” are synonymous.

In the present specification, a combination of two or more preferred aspects is a more preferred aspect.

[Antibacterial Film]

An antibacterial film according to the embodiment of the present invention (hereinafter, also referred to as “the present antibacterial film”) contains a base material and at least one antibacterial layer disposed on the base material, and the antibacterial layer contains a binder, a light diffusing particle, and an antibacterial agent particle.

In addition, the present antibacterial film satisfies the following condition 1.

The condition 1:

An average value Ha of hazes (a haze Ha) of the antibacterial film in a wavelength range of 380 to 570 nm, an average value Hb of hazes (a haze Hb) of the antibacterial film in a wavelength range of more than 570 nm and 750 nm or less, and an average value Hc of hazes (a haze Hc) of the antibacterial film in a wavelength range of 380 to 750 nm satisfy Expression (1).

0≤|Ha−Hb|/Hc≤0.15 (1)

As a result of carrying out intensive studies on an antibacterial film having an antiglare function, the inventors of the present invention found that there is room for further improvement in image visibility. On the other hand, the inventors of the present invention found that, in an antibacterial film having an antibacterial layer containing a binder, a light diffusing particle, and an antibacterial agent particle, in a case where a value calculated according to an expression of |Ha−Hb|/Hc from the haze Ha, the haze Hb, and the haze Hc in the specific wavelength range as described above (hereinafter, also referred to as a “specific haze ratio”) is adjusted in a range of 0 to 0.15, an effect that the image visibility can be improved while maintaining the antibacterial properties and the antiglare function (hereinafter, also referred to as “the effect of the present invention”) is exhibited, whereby the present invention was completed.

Although the detailed reason why the effect of the present invention is exhibited by adjusting the specific haze ratio to the above-described range is not clear, it is presumed that the difference in the turbidity between the tone of a range of purple to yellow and the tone of a range of yellow to red, where the ranges corresponding to the respective wavelength ranges, becomes small and the difference in the change in the tone between the two wavelength ranges becomes small, whereby the image visibility is improved.

Hereinafter, the configuration of the present antibacterial film will be described with reference to the drawing.

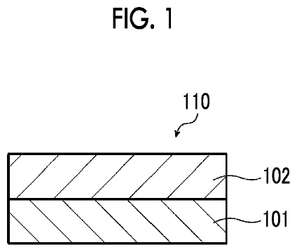

FIG. 1 is a cross-sectional view illustrating an example of a configuration of the present antibacterial film. An antibacterial film 110 has a base material 101 and an antibacterial layer 102. The antibacterial layer 102 contains antibacterial agent particles, which are not illustrated in the drawing. In the antibacterial film 110, the surface of the base material 101 is in direct contact with the antibacterial layer 102.

The present antibacterial film is not limited to the configuration illustrated in FIG. 1, and it may have another configuration.

In the antibacterial film illustrated in FIG. 1, the antibacterial layer 102 is disposed on a surface of one side of the base material 101; however, the antibacterial layer may be disposed on both surfaces of the base material.

In the antibacterial film 110 illustrated in FIG. 1, the antibacterial layer 102 is disposed on the entire surface of the base material 101; however, the antibacterial layer may be disposed only on a part of the base material.

In the antibacterial film 110 illustrated in FIG. 1, a pressure-sensitive adhesive layer may be disposed on a surface of the base material 101 opposite to the surface on which the antibacterial layer 102 is disposed. In this case, a separator that protects the pressure-sensitive adhesive layer may be further attached to a surface of the pressure-sensitive adhesive layer opposite to the surface on which the base material 101 is disposed.

Further, in the antibacterial film 110 illustrated in FIG. 1, a protective sheet for protecting the antibacterial layer 102 may be disposed on the antibacterial layer 102. In a case where a protective sheet is disposed, the protective sheet is removed from the antibacterial film at the time of the use.

In the antibacterial film 110 illustrated in FIG. 1, the base material 101 is in direct contact with the antibacterial layer 102; however, a primer layer may be included between the base material and the antibacterial layer.

Hereinafter, each member constituting the antibacterial film will be described in detail.

[Base Material]

The present antibacterial film has a base material. The base material is not particularly limited, and a known base material can be used.

The base material is preferably a transparent base material. Here, the “transparent base material” means that the transmittance thereof for a ray having a wavelength of 380 to 780 nm is 80% or more.

From the viewpoint of transparency of the base material, it is preferable that the number of fine particles, foreign substances, and defects included in the base material is small. The number of fine particles having a diameter of 1 μm or more, foreign substances, and defects in the base material is preferably 50 pieces/10 mm² or less, more preferably 10 pieces/10 mm² or less, still more preferably 3 pieces/10 mm² or less, and particularly preferably 0 pieces/10 mm².

In a case where a polyethylene terephthalate (PET) film is used as the base material, a base material that has been subjected to a stretching treatment is preferable, and a base material that has been subjected to biaxial stretching is more preferable, from the viewpoint of improving mechanical strength. The stretching ratio is not particularly limited; however, it is preferably in a range of 1.5 times or more and 7 times or less. In a case where the stretching ratio is smaller than 1.5 times, the mechanical strength may be insufficient, and in a case where the stretching ratio is more than 7 times, the base material may lack thickness uniformity. The stretching ratio is more preferably in a range of 2 times or more and 5 times or less. A particularly preferred stretching ratio in terms of a stretching direction is in a range of 2 times or more and 5 times or less in each of the two directions orthogonal to each other.

As the optical characteristics of the base material, it is preferable that the haze value is 0.5% to 1.5% and the total light transmittance is 90% or more.

The base material is preferably a base material in which the arithmetic average roughness Ra of the surface satisfies Expression (a), and it is more preferably a base material in which the arithmetic average roughness Ra of the surface satisfies Expression (a1).

0.005 μm<Ra<0.02 μm (a)

0.008 μm<Ra<0.015 μm (a1)

In addition, the base material is preferably a base material in which the arithmetic average roughness Ra and the maximum height Rz of the surface satisfy Expression (b), and it is more preferably a base material in which the arithmetic average roughness Ra and the maximum height Rz of the surface satisfy Expression (b1).

5<Rz/Ra<50 (b)

10<Rz/Ra<30 (b1)

Among the above, it is particularly preferable that the surface of the base material satisfies both Expression (a) and Expression (b), and it is most preferable that the surface of the base material satisfies both Expression (a1) and Expression (b1).

The arithmetic average roughness Ra and the maximum height Rz of the surface of the base material can be measured by analyzing the shape of the surface of the base material using a laser microscope (for example, “VK-X1000” manufactured by KEYENCE CORPORATION) in accordance with ISO 4287.

Examples of the material constituting the base material include polyethylene terephthalate (PET), triacetyl cellulose (TAC), polycarbonate (PC), polybutylene terephthalate (PBT), and polyimide. Among them, polyethylene terephthalate (PET), triacetyl cellulose (TAC), or polycarbonate (PC) is preferable from the viewpoint of ease of handling and excellent transparency, and a biaxially stretched polyethylene terephthalate (PET) film is particularly preferable as the base material.

Examples of the PET film include “Lumirror (registered trade name) U34” manufactured by Toray Industries, Inc., “COSMOSHINE (registered trade name) A4300” manufactured by TOYOBO Co., Ltd., and “O3916W” manufactured by TEIJIN LIMITED.

The shape of the base material is not particularly limited; however, examples thereof include a film shape and a sheet shape. In addition, the surface of the base material on which the antibacterial layer described later is disposed may be a flat surface or a curved surface.

From the viewpoint that more excellent handleability can be imparted, an easy adhesion layer (a primer layer) known in the related art may be formed on the surface of the base material on the side on which the antibacterial layer is disposed.

Examples of the easy adhesion layer include a layer containing particles and a binder. The volume average particle diameter of the particles contained in the easy adhesion layer is preferably 0.05 to 0.8 μm. The film thickness of the easy adhesion layer is preferably 0.05 to 1.0 μm.

The thickness of the base material is not particularly limited; however, it is preferably 10 to 300 μm and more preferably 50 to 150 μm. It is noted that the thickness of the base material is an arithmetic average value of thicknesses at any 10 points of the base material, which are measured with a micrometer.

[Antibacterial Layer]

The antibacterial layer contains at least a binder, a light diffusing particle, and an antibacterial agent particle.

<Antibacterial Agent Particle>

The antibacterial agent particle is not particularly limited, and a known particulate antibacterial agent can be used. It is noted that as the antibacterial agent particles, those that exhibit a bactericidal effect against pathogenic bacteria such as Staphylococcus aureus and Escherichia coli are preferably used.

The shape of the antibacterial agent particle is not particularly limited, and it may be, for example, a spherical shape, an elliptical spherical shape, a rod shape, a flat plate shape, a needle shape, an indefinite shape, or the like.

The antibacterial agent particle preferably contains a metal. This is because a metal ion is generated from the metal contained in the antibacterial agent particle, and the metal ion acts on microorganisms (hereinafter, also referred to as bacteria) to exhibit antibacterial properties.

It is also preferable in that not only an antibacterial effect against pathogenic bacteria but also antibacterial properties against fungi such as mold as well as antiviral properties against viruses are exhibited. Examples of the virus having the effect include an influenza virus, a SARS coronavirus (SARS-CoV), and a novel coronavirus (SARS-CoV-2). As an evaluation method for antiviral properties, a known means can be used. For example, by using the method described in ISO 21702, the antiviral properties can be measured by changing a test virus to a virus of interest such as an influenza virus, a SARS coronavirus, or a novel coronavirus. The antiviral activity value may be larger than 1; however, it is preferably 2.0 or more and more preferably more than 2.0.

Examples of the metal include silver, mercury, zinc, iron, lead, bismuth, titanium, tin, and nickel. In addition, the aspect of the metal contained in the antibacterial agent particle is not particularly limited, and examples thereof include forms such as a metal particle, a metal ion, and a metal salt (including a metal complex).

Among them, the metal is preferably copper, zinc, or silver from the viewpoint that the antibacterial layer has more excellent antibacterial properties, and it is preferably silver from the viewpoint that the safety is high and the antibacterial spectrum is broad. In addition, the metal is preferably a metal salt. It is noted that one kind of antibacterial agent particle may be used alone, or two or more kinds thereof may be used in combination.

The antibacterial agent particle is preferably an antibacterial agent particle containing silver (hereinafter, also referred to as a “silver-based antibacterial agent”) from the viewpoint that the antibacterial layer has more excellent antibacterial properties. That is, it is preferable that the metal is silver.

It suffices that the silver-based antibacterial agent contains silver (a silver atom), and the kind thereof is not particularly limited. In addition, the form of silver is not particularly limited, and the silver is included, for example, in a form of metallic silver, a silver ion, or a silver salt (including a silver complex). Examples of the silver-based antibacterial agent include silver particles that slowly release silver ions and inorganic antibacterial agents containing silver (for example, those obtained by causing a carrier to support silver and/or silver ions). According to the present specification, a silver complex is included in the range of the silver salt.

Examples of the silver salt include silver acetate, silver acetylacetonate, silver azide, silver acetylide, silver arsenate, silver benzoate, silver hydrogen fluoride, silver bromate, silver bromide, silver carbonate, silver chloride, silver chlorate, silver chromate, silver citrate, silver cyanate, silver cyanide, silver (cis,cis-1,5-cyclooctadiene)-1,1,1,5,5,5-hexafluoroacetylacetonate, silver diethyldithiocarbamate, silver(I) fluoride, silver(II) fluoride, silver 7,7-dimethyl-1,1,1,2,2,3,3-heptafluoro-4,6-octanedionate, silver hexafluoroantimonate, silver hexafluoroarsenate, silver hexafluorophosphate, silver iodate, silver iodide, silver isothiocyanate, potassium silver cyanide, silver lactate, silver molybdate, silver nitrate, silver nitrite, silver(I) oxide, silver(II) oxide, silver oxalate, silver perchlorate, silver perfluorobutyrate, silver perfluoropropionate, silver permanganate, silver perrhenate, silver phosphate, silver picrate monohydrate, silver propionate, silver selenate, silver selenide, silver selenite, sulfadiazine silver, silver sulfate, silver sulfide, silver sulfite, silver telluride, silver tetrafluoroborate, silver tetraiodomercurate, silver tetratungstate, silver thiocyanate, silver p-toluenesulfonate, silver trifluoromethanesulfonate, silver trifluoroacetate, and silver vanadate.

In addition, examples of the silver complex include a histidine-silver complex, a methionine-silver complex, a cysteine-silver complex, an aspartic acid-silver complex, a pyrrolidone carboxylate-silver complex, an oxotetrahydrofuran carboxylate-silver complex, and an imidazole-silver complex.

Among them, from the viewpoint that the antibacterial properties are more excellent, the silver-based antibacterial agent is preferably a silver supporting carrier including a carrier and silver supported on the carrier.

The antibacterial agent particle is preferably a metal supporting carrier including a carrier and a metal supported on the carrier, and it is more preferably a silver supporting carrier. The kind of the carrier is not particularly limited, and a known carrier can be used.

Examples of the carrier include a zeolite-based antibacterial agent carrier, a calcium silicate-based antibacterial agent carrier, a zirconium phosphate-based antibacterial agent carrier, a calcium phosphate antibacterial agent carrier, a zinc oxide-based antibacterial agent carrier, a soluble glass-based antibacterial agent carrier, a silica gel-based antibacterial agent carrier, an activated carbon-based antibacterial agent carrier, a titanium oxide-based antibacterial agent carrier, a titania-based antibacterial agent carrier, an organic metal-based antibacterial agent carrier, an ion exchanger ceramic-based antibacterial agent carrier, a layered phosphate-quaternary ammonium salt-based antibacterial agent carrier, and an antibacterial stainless steel carrier, which are not limited thereto.

More specific examples of the carrier include zinc-calcium phosphate, calcium phosphate, zirconium phosphate, aluminum phosphate, calcium silicate, activated carbon, activated alumina, silica gel, zeolite, hydroxyapatite, zirconium phosphate, titanium phosphate, potassium titanate, bismuth oxide hydrate, zirconium oxide hydrate, and hydrotalcite. Here, examples of the zeolite include natural zeolites such as chabazite, mordenite, erionite, and clinoptilolite and synthetic zeolites such as type A zeolite, type X zeolite, and type Y zeolite.

In addition, the carrier is preferably a so-called ceramic from the viewpoint that the effect of the present invention is more excellent. That is, the antibacterial agent particle is preferably a metal supporting ceramic particle and more preferably a silver supporting ceramic particle.

The carrier may be crystalline or non-crystalline (amorphous); however, it is preferably crystalline.

In a case where the antibacterial agent particle contains a metal, the content of the metal is not particularly limited; however, it is preferably 0.1% to 30% by mass and more preferably 0.5% to 20% by mass with respect to the total mass of the antibacterial agent particle (the metal supporting carrier).

Examples of the commercially available silver-based antibacterial agent include silver zeolite-based antibacterial agents such as “Zeomic” manufactured by Sinanen Zeomic Co., Ltd., “Silwell” manufactured by Fuji Silysia Chemical Ltd., and “Bactenon” manufactured by JAPAN ELECTRONIC MATERIALS CORPORATION; silver-based antibacterial agent obtained by supporting silver on an inorganic ion exchanger ceramic, such as “NOVARON” manufactured by Toagosei Co., Ltd. and “ATOMY BALL” manufactured by JGC Catalysts and Chemicals Ltd.; silver particles such as a “Nanosilver” manufactured by JAPAN ION Corporation; and silver supporting ceramic particles (silver ceramic particles) in which silver is chemically bonded to a ceramic, such as “Bactekiller” and “Bactelite” manufactured by Fuji Chemical Industries, Ltd.

The average particle diameter of the antibacterial agent particles is preferably 0.1 to 10 μm and more preferably 0.3 to 3 μm from the viewpoint that the ease of handling and the transparency of the antibacterial layer are excellent in a well-balanced manner.

It is noted that the cumulative diameter (D50) at 50% by volume is measured three times using a laser diffraction scattering-type particle size distribution analyzer manufactured by HORIBA, Ltd., and an arithmetic average value of the obtained measured values is used as the average particle diameter of the antibacterial agent particles.

One kind of antibacterial agent particle may be used alone, or two or more kinds thereof may be used.

The content of the antibacterial agent particle in the antibacterial layer is not particularly limited; however, from the viewpoint that the effect of the present invention is more excellent, it is preferably 0.1% to 20% by mass, more preferably 0.2% to 10% by mass, and still more preferably 1.0% to 7% by mass, with respect to the total mass of the antibacterial layer.

In addition, in a case where the antibacterial agent particle contains a metal, the coating amount of the antibacterial agent particle per area of the antibacterial layer is preferably 3 mg/m² or more and more preferably 5 mg/m² or more in terms of the content of the metal contained in the antibacterial agent particle from the viewpoint of imparting antiviral properties. The upper limit value thereof is not particularly limited; however, it is preferably 10 mg/m² or less.

One kind of antibacterial agent particle may be used alone, or two or more kinds of antibacterial agent particles may be used in combination. In addition, an antibacterial agent other than the antibacterial agent particle may be used in combination with the antibacterial agent particle.

Examples of other antibacterial agents include organic antibacterial agents such as a phenol ether derivative, an imidazole derivative, a sulfone derivative, an N-haloalkylthio compound, an anilide derivative, a pyrrole derivative, a quaternary ammonium salt, a pyridine-based compound, a triazine-based compound, a benzoisothiazoline-based compound, and an isothiazoline-based compound.

Here, the organic antibacterial agent also includes a natural antibacterial agent. Examples of the natural antibacterial agent include chitosan, which is a basic polysaccharide obtained by hydrolyzing chitin contained in the shell of a crab or shrimp.

In a case where the antibacterial agent particle is used in combination with another antibacterial agent, it is important to select a combination that does not impair the antibacterial properties.

<Binder>

The antibacterial layer contains a binder.

The binder is not particularly limited, and a known binder can be used. Examples of the binder include a polyester resin, an acrylic resin, a methacrylic resin, a resin consisting of a methacrylic acid-maleic acid copolymer, a polystyrene resin, a fluororesin, a polyimide resin, a fluorinated polyimide resin, a polyamide resin, a polyamide imide resin, a polyether imide resin, a cellulose acylate resin, a polyurethane resin, a polyether ether ketone resin, a polycarbonate resin, an alicyclic polyolefin resin, a polyarylate resin, a polyether sulfone resin, a polysulfone resin, a resin consisting of a cycloolefin copolymer, a fluorene ring-modified polycarbonate resin, an alicyclic modified polycarbonate resin, and a fluorene ring-modified polyester resin.

The binder contained in the antibacterial layer is preferably a polymer having a hydrophilic group (hereinafter, also referred to as a “hydrophilic polymer”). In a case where the antibacterial layer contains a hydrophilic polymer, the antibacterial layer further exhibits hydrophilicity, the antibacterial properties are more excellent, and contaminants adhered to the surface of the antibacterial layer can be more easily removed by washing with a washing solution such as water.

The kind of hydrophilic group is not particularly limited, and examples include a polyoxyalkylene group (a polyoxyethylene group, a polyoxypropylene group, a polyoxyalkylene group in which oxyethylene groups and oxypropylene groups are block-bonded or randomly bonded, or the like), an amino group, a carboxy group, an alkali metal salt of a carboxy group, a hydroxyl group, an alkoxy group, an amide group, a carbamoyl group, a sulfonamide group, a sulfamoyl group, a sulfonate group, and an alkali metal salt of a sulfonate group. Among them, a polyoxyalkylene group is preferable from the viewpoint that the effect of the present invention is more excellent.

The structure of the main chain of the hydrophilic polymer is not particularly limited, and examples include polyurethane, poly(meth)acrylate, polystyrene, polyester, polyamide, polyimide, and polyurea.

It is noted that the poly(meth)acrylate is a concept including both polyacrylate and polymethacrylate.

The hydrophilic polymer is preferably a polymer obtained by polymerizing a monomer having the above-described hydrophilic group (hereinafter, also referred to as a “hydrophilic monomer”). The hydrophilic monomer means a compound (a monomer and/or an oligomer) having the above-described hydrophilic group and a polymerizable group.

The number of hydrophilic groups in the hydrophilic monomer is not particularly limited; however, due to the fact that the antibacterial layer exhibits stronger hydrophilicity, the number of hydrophilic groups is preferably 1 or more, more preferably 1 to 6, and still more preferably 1 to 3.

The kind of the polymerizable group in the hydrophilic monomer is not particularly limited, and examples thereof include a radically polymerizable group, a cationically polymerizable group, and an anionically polymerizable group. Examples of the radically polymerizable group include a (meth)acryloyl group, an acrylamide group, a vinyl group, a styryl group, and an allyl group. Examples of the cationically polymerizable group include a vinyl ether group, an oxiranyl group, and an oxetanyl group. Among them, a (meth)acryloyl group is preferable. The (meth)acryloyl group is a concept including both an acryloyl group and a methacryloyl group.

The number of polymerizable groups in the hydrophilic monomer is not particularly limited; however, from the viewpoint that the antibacterial layer to be obtained is more excellent in mechanical strength, the number of polymerizable groups is preferably 2 or more, more preferably 2 to 6, and still more preferably 2 to 3.

One of the suitable aspects of the hydrophilic monomer may be a compound represented by Formula (A).

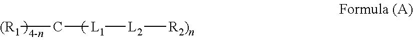

In Formula (A), R₁ represents a hydrogen atom or a substituent (a monovalent substituent). The kind of the substituent is not particularly limited, and a known substituent may be used. Examples of the substituents include a hydrocarbon group (for example, an alkyl group or an aryl group) which may have a heteroatom, and the above-described hydrophilic group.

R₂ represents a polymerizable group. The definition of the polymerizable group is as described above.

L₁ represents a single bond or a divalent linking group. The kind of the divalent linking group is not particularly limited, and examples thereof include —O—, —CO—, —NH—, —CO—NH—, COO—, —O—COO—, an alkylene group, an arylene group, a heteroaryl group, and combinations thereof.

L₂ represents a polyoxyalkylene group. The polyoxyalkylene group means a group represented by Formula (B).

*—(OR₃)ₘ—* Formula (B)

In Formula (B), R₃ represents an alkylene group (for example, an ethylene group or a propylene group). m represents an integer of 2 or more, and it is preferably 2 to 10 and more preferably 2 to 6. Here, * represents a bonding position.

n represents an integer of 1 to 4.

As the hydrophilic monomer having a hydrophilic group and a polymerizable group, a commercially available product can be used. Examples of such a commercially available product include “NK ESTER A-GLY-9E” manufactured by SHIN-NAKAMURA CHEMICAL Co., Ltd., “Miramer M4004” manufactured by TOYO CHEMICALS Co., Ltd., and “Miramer M3150” manufactured by Toyo Chemicals Co., Ltd.

From the viewpoint that the mechanical strength of the antibacterial layer is more excellent, it is preferable to use a polyfunctional monomer having two or more polymerizable groups at the time of producing a hydrophilic polymer. This is because the polyfunctional monomer acts as a so-called crosslinking agent, has a three-dimensional network structure in which metal ions such as silver ions easily move, and enables the production of a hydrophilic polymer that exhibits more excellent antibacterial properties. From the above viewpoint, it is preferable to use two or more kinds of polyfunctional monomers. The polyfunctional monomer may have or may not have a hydrophilic group.

The number of polymerizable groups contained in the polyfunctional monomer is not particularly limited, and from the viewpoint of the more excellent mechanical strength of the antibacterial layer and the handleability, it is preferably 2 to 10 and more preferably 2 to 6.

Examples of the polyfunctional monomer include trimethylolpropane triacrylate, tetramethylolmethane tetraacrylate, dipentaerythritol hexaacrylate, pentaerythritol triacrylate, and pentaerythritol tetraacrylate.

As such a polyfunctional monomer (a crosslinking agent), a commercially available product can be used. Examples of such a commercially available product include “DPHA-76” (dipentaerythritol hexaacrylate) manufactured by Toshin Yushi Co., Ltd. “KAYARAD PET-30” (a mixture of pentaerythritol triacrylate and pentaerythritol tetraacrylate) manufactured by Nippon Kayaku Co., Ltd., and “A-DPH” (dipentaerythritol hexaacrylate) manufactured by SHIN-NAKAMURA CHEMICAL Co., Ltd.

The hydrophilic polymer is preferably a copolymer consisting of two or more kinds of hydrophilic monomers different from each other. In a case of using two or more kinds of hydrophilic monomers different from each other in the number of functional groups and the properties such as hydrophilicity, it is possible to control the strength, hydrophilicity, and/or optical characteristics of the antibacterial layer, and it is possible to impart properties according to the intended purpose to the antibacterial layer.

From the above viewpoint, the hydrophilic polymer is more preferably a copolymer consisting of one or more kinds of compounds represented by Formula (A) and one or more kinds of polyfunctional monomers, and it is still more preferably a copolymer consisting of one or more kinds of compounds represented by Formula (A) and two or more kinds of polyfunctional monomers.

In a case where the hydrophilic polymer is a copolymer of the compound represented by Formula (A) and a polyfunctional monomer, the mixing ratio of the compound represented by Formula (A) to the polyfunctional monomer is not particularly limited. However, the ratio of the content (the total content) of the compound represented by Formula (A) to the content (the total content) of the polyfunctional monomer is preferably 0.01 to 10 and more preferably 0.03 to 1 in terms of mass ratio.

As the binder, it is possible to use latex having the above-described composition. Although various types of latex can be used, acrylic latex is preferable from the viewpoint of having hydrophilicity and being capable of utilizing water-based coating. From the same viewpoint, it is also preferable to use an aqueous polymer such as polyvinyl alcohol as one aspect of the binder.

Further, as the binder having hydrophilicity, it is also possible to use a siloxane resin which is a polymer of a silicate-based compound. The silicate-based compound is a compound selected from the group consisting of a compound obtained by bonding a hydrolyzable group to a silicon atom, a hydrolyzate thereof, and a hydrolysis condensate thereof.

One kind of binder may be used alone, or two or more kinds thereof may be used in combination.

The content of the binder in the antibacterial layer is not particularly limited. However, from the viewpoint that the antibacterial layer has more excellent effect of the present invention, it is preferably 3% to 95% by mass, more preferably 5% to 90% by mass, and still more preferably 10% to 85% by mass, with respect to the total mass of the antibacterial layer.

<Light Diffusing Particle>

The antibacterial layer contains light diffusing particles.

The light diffusing particle is not particularly limited as long as it is a particle that functions as a so-called matting agent. It may be an organic particle, may be an inorganic particle, or may be an organic-inorganic composite particle.

Examples of the organic particle include a resin particle. More specific examples thereof include a silicone resin particle, an acrylic resin particle such as polymethylmethacrylate (PMMA), a nylon resin particle, a styrene resin particle, a polyethylene particle, a urethane resin particle, and a benzoguanamine particle. The organic particle may be a particle having a hollow structure.

As the inorganic particle, it is possible to use a particle such as diamond, titanium oxide, zirconium oxide, lead oxide, lead carbonate, zinc oxide, zinc sulfide, antimony oxide, silicon oxide, or aluminum oxide, and titanium oxide or aluminum oxide is preferable from the viewpoint of availability of particles having a suitable refractive index.

The light diffusing particle is preferably a silicone resin particle or an acrylic resin particle and more preferably an acrylic resin particle from the viewpoint of being more excellent in antiglare function due to light scattering.

Examples of the commercially available product of such a light diffusing particle include “MX-500”, “MX-300”, and “MX-80h3wT”, manufactured by Soken Chemical & Engineering Co., Ltd., and “SSX-103” manufactured by Sekisui Chemical Company, Limited.

The average particle diameter of the light diffusing particles is preferably 0.1 to 15 μm, more preferably 0.3 to 10 μm, and still more preferably 0.5 to 5 μm, from the viewpoint of being more excellent in antiglare function.

One kind of light diffusing particle may be used alone, or two or more kinds thereof may be used in combination.

The content of the light diffusing particles is not particularly limited. However, from the viewpoint that the antibacterial layer has more excellent effect of the present invention, it is preferably 1% to 15% by mass, more preferably 3% to 12% by mass, and still more preferably 6% to 8% by mass, with respect to the total mass of the antibacterial layer.

<Optional Component>

The antibacterial layer may contain an optional component other than those described above as long as the effect of the present invention is exhibited.

Examples of the optional component include a dispersing agent, a surfactant, a photocatalytic material, and a hydrophilicity imparting agent.

(Dispersing Agent)

The antibacterial layer may contain a dispersing agent. The dispersing agent is a compound having a function of improving the dispersibility of the antibacterial agent particles.

The dispersing agent is not particularly limited, and a known dispersing agent can be used. However, a dispersing agent having an acidic group is preferable, and a dispersing agent having both an acidic group and a basic group is more preferable.

Examples of the acidic group include a carboxyl group, a sulfonate group, and a phosphate group. Examples of the basic group include an amino group and an amide group.

Examples of the commercially available product of the dispersing agent include DISPERBYK-102, DISPERBYK-106, DISPERBYK-108, DISPERBYK-110, DISPERBYK-111, DISPERBYK-140, DISPERBYK-142, DISPERBYK-9076, DISPERBYK-118, and DISPERBYK-180 (all, manufactured by BYK Additives & Instruments), Solsperse 26000, Solsperse 36000, and Solsperse 41000 (all, manufactured by Lubrizol), and AZSPAR PB821, AJISPER PB822, AJISPER PB824, and AJISPER PB881 (all, manufactured by Ajinomoto Fine-Techno Co., Inc.).

Among them, DISPERBYK-180 or AJISPER PB881, which has both an acidic group and a basic group, is preferable.

One kind of dispersing agent may be used alone, or two or more kinds thereof may be used in combination.

In a case where the antibacterial layer contains a dispersing agent, the content of the dispersing agent is preferably 10% to 500% by mass with respect to the total mass of the antibacterial agent particle.

(Surfactant)

The antibacterial layer may contain a surfactant. The water contact angle on the surface of the antibacterial layer can be adjusted to a desired range with a surfactant. In addition, in a case where an antibacterial layer is formed according to a coating method by using the following composition for forming an antibacterial layer, a coating film having a more uniform thickness and/or a coating film having a smooth surface is easily formed.

The surfactant is not particularly limited, and a known surfactant can be used. Examples of the surfactant include a nonionic surfactant, an anionic surfactant, a cationic surfactant, and an amphoteric surfactant.

Examples of the type of the nonionic surfactant include an ester type such as a glycerin fatty acid ester, a sorbitan fatty acid ester, or a sucrose fatty acid ester, an ether type such as a polyoxyethylene alkyl ether or a polyoxyethylene polyoxypropylene glycol, an ester ether type such as a fatty acid polyethylene glycol or a fatty acid polyoxyethylene sorbitan, and an alkanol amide type such as a fatty acid alkanol amide.

Specific examples of the nonionic surfactant include polyethylene glycol mono(meth)acrylate, polyethylene glycol monolauryl ether, polyethylene glycol monostearyl ether, polyethylene glycol monocetyl ether, polyethylene glycol monolauryl ester, and polyethylene glycol monostearyl ester.

Examples of the ionic surfactant include anionic surfactants such as an alkyl sulfate, an alkylbenzene sulfonate, and an alkyl phosphate; cationic surfactants such as an alkyltrimethylammonium salt and a dialkyldimethylammonium salt; and amphoteric surfactants such as an alkyl carboxybetaine.

In addition, examples of the surfactant include a fluorine-based surfactant. Examples of the fluorine-based surfactant include the compounds described in paragraphs [0082] to [0090] of JP2014-119605A.

It is also preferable that the fluorine-based surfactant contains a polymerizable group. Examples of the surfactant containing a polymerizable group include X-71-1203E (manufactured by Shin-Etsu Chemical Co., Ltd.), Fluoro Surf (registered trade name) FS-7072 (manufactured by Fluoro Technology Co., Ltd.), and MEGAFACE (registered trade name) F-780-F, RS-101, RS-102, RS-718K, and RS-72-K (all, manufactured by DIC Corporation).

Due to the environmental suitability of a compound having a linear perfluoroalkyl group having 7 or more carbon atoms, it is preferable to use alternative materials of PFOA and PFOS as the fluorine-based surfactant.

One kind of surfactant may be used alone, or two or more kinds thereof may be used in combination.

In a case where the antibacterial layer contains a surfactant, the content of the surfactant is preferably 0.1% to 10% by mass with respect to the total mass of the antibacterial layer.

(Photocatalytic Material)

The antibacterial layer may contain a photocatalytic material including a metal oxide.

The kind of the metal oxide included in the photocatalytic material is not particularly limited. However, examples thereof include TiO₂, ZnO, SrTiO₃, CdS, GaP, InP, GaAs, BaTiO₃, BaTiO₄, BaTi₄O₉, K₂NbO₃, Nb₂O₅, Fe₂O₃, Ta₂O₅, K₃Ta₃Si₂O₃, WO₃, SnO₂, Bi₂O₃, BiVO₄, NiO, Cu₂O, SiC, MoS₂, InPb, RuO₂, CeO₂, and Ta₃N₅, as well as a layered oxide having at least one element selected from Ti, Nb, Ta, and V. Among them, a metal oxide containing at least one metal atom selected from the group consisting of Zn, Ti, Ni, W, Cu, Sn, Fe, Sr, and Bi is preferable.

The average particle diameter of the photocatalytic material (excluding those that are used as the antibacterial agent particles) is not particularly limited; however, it is preferably 1 nm or more and 2 μm or less. The average particle diameter of the photocatalytic material can be measured according to the same method as the measuring method for the average particle diameter of the antibacterial agent particles.

In a case where the antibacterial layer contains a photocatalytic material, the mass ratio of the mass of the antibacterial agent particle to the mass of the photocatalytic material (the mass of the antibacterial agent particle/the mass of the photocatalytic material) is preferably 0.01 to 20, more preferably 0.1 to 10, and still more preferably 0.3 to 3.

(Hydrophilicity Imparting Agent)

The antibacterial layer may contain a hydrophilicity imparting agent. The hydrophilicity imparting agent is a compound having a function of decreasing the water contact angle on the surface of the antibacterial layer, where it is intended not to be included in the surfactant. The hydrophilicity imparting agent is not particularly limited as long as it is a compound having a function of decreasing the water contact angle on the surface of the antibacterial layer, and examples thereof include ethyl (meth)acrylate, n-butyl (meth)acrylate, and isobutyl (meth)acrylate.

One kind of hydrophilicity imparting agent may be used alone, or two or more kinds thereof may be used in combination.

In a case where the antibacterial layer contains a hydrophilicity imparting agent, the content of the hydrophilicity imparting agent is preferably 0.1% to 30% by mass with respect to the total mass of the antibacterial layer.

Examples of the optional component other than those described above, which may be contained in the antibacterial layer, include a polymerization initiator, an ultraviolet absorbing agent, a filler, an anti-aging agent, an antistatic agent, a flame retardant, an adhesiveness imparting agent, an antioxidant, an antifoaming agent, a leveling agent, a matting agent, a light stabilizer, a deodorant, a dye, a fragrance, and a pigment.

<Physical Properties of Antibacterial Layer>

(Thickness)

The thickness of the antibacterial layer is not particularly limited; however, it is preferably 0.01 to 10 μm, more preferably 0.01 to 5 μm, and still more preferably 0.01 to 3 μm from the viewpoint that durability and transparency are excellent in a well-balanced manner.

It is noted that the thickness of the antibacterial layer is determined by embedding a sample piece having the antibacterial layer in a resin, cutting out a cross section with a microtome, and observing the cut-out cross section with a scanning electron microscope to measure the thickness. The thickness of the antibacterial layer is an arithmetic average value of thicknesses of the antibacterial layer at any 10 points of the antibacterial layer, which are measured according to the above-described method.

(Water Contact Angle)

The water contact angle on the surface of the antibacterial layer is preferably 20 degrees or more and more preferably 70 degrees or more since dirt such as sebum does not easily adhere to the surface of the antibacterial layer. The upper limit value thereof is not particularly limited; however, it is preferably 120 degrees or less and more preferably 110 degrees or less.

In the present specification, the water contact angle refers to a water contact angle measured according to the following method. Using a contact angle meter (FAMMS DM-701, manufactured by Kyowa Interface Science Co., Ltd.), pure water (2 μL of a droplet) is dropped onto the surface of the antibacterial layer that is kept to be horizontal. The contact angle 20 seconds after the dropping is measured at 10 points, and the arithmetic average value from the measurement results is used as the water contact angle of the antibacterial layer. It is noted that the measurement is carried out under the condition of room temperature of 20° C. in accordance with the sessile drop method of Japanese Industrial Standards (JIS) R3257: 1999.

The antibacterial film may have a layer other than the above-described base material and antibacterial layer.

Examples of the layer other than the base material and the antibacterial layer include a pressure-sensitive adhesive layer, a release film, the protective sheet described above, and the easy adhesion layer (the primer layer) described above.

The antibacterial film may have a pressure-sensitive adhesive layer.

The pressure-sensitive adhesive layer is for attaching the antibacterial film to various antibacterial layer-forming surfaces of devices. The pressure-sensitive adhesive layer may be any pressure-sensitive adhesive layer as long as the antibacterial film can be attached to various antibacterial layer-forming surfaces, or it may be a pressure-sensitive adhesive layer formed of a known pressure-sensitive adhesive.

Examples of the pressure-sensitive adhesive that can be used for the pressure-sensitive adhesive layer include a (meth)acrylic pressure-sensitive adhesive, a rubber-based pressure-sensitive adhesive, a silicone-based pressure-sensitive adhesive, a urethane-based pressure-sensitive adhesive, and a polyester-based pressure-sensitive adhesive. The (meth)acrylic pressure-sensitive adhesive is intended to be an acrylic pressure-sensitive adhesive and/or a methacrylic pressure-sensitive adhesive.

In a case where the antibacterial film has a pressure-sensitive adhesive layer, it is preferable that the antibacterial layer is disposed on one surface of the base material, and the pressure-sensitive adhesive layer is disposed on a surface opposite to the surface on which the antibacterial film of the base material is disposed. As a result, the antibacterial layer is disposed on a side closer to the exposed surface in a case where the antibacterial film is attached to the antibacterial layer-forming surface of the device.

The thickness of the pressure-sensitive adhesive layer is not particularly limited; however, it is preferably 1 to 30 μm and more preferably 2 to 20 μm.

The pressure-sensitive adhesive force of the pressure-sensitive adhesive layer is not particularly limited; however, it is preferably 2 to 20 cN/25 mm. In a case where the pressure-sensitive adhesive force is 2 cN/25 mm or more, curling or the like hardly occurs at the time when the pressure-sensitive adhesive layer is used by being attached to the surface of the touch panel or the like. On the other hand, in a case where the pressure-sensitive adhesive force is 20 cN/25 mm or less, the antibacterial film can be smoothly peeled off.

In a case where the antibacterial film has a pressure-sensitive adhesive layer, it is preferable that the antibacterial film further has a release film.

The release film is adhered to the pressure-sensitive adhesive layer to protect the pressure-sensitive adhesive layer until the use of the antibacterial film. The release film may be any release film as long as it can protect the pressure-sensitive adhesive layer, and a known release film can be used. Examples of the material of the release film include a mold release agent such as a silicone-based compound, a long-chain alkyl-based compound, or polyvinyl alcohol carbamate.

The thickness of the release film is not particularly limited; however, it is preferably 1 to 30 μm and more preferably 2 to 20 μm.

[Manufacturing Method for Antibacterial Film]

A manufacturing method for an antibacterial film is not particularly limited as long as it enables the production of an antibacterial film having a base material and an antibacterial layer disposed on the base material. Examples of the manufacturing method for an antibacterial film include a method of forming an antibacterial layer on a base material, a method of forming a base material on an antibacterial layer, a method of bonding a preformed antibacterial layer to a preformed base material, and a method of adhering an antibacterial layer to a base material while forming them by co-extrusion or the like.

Among them, a method (a coating method) of applying a composition for forming an antibacterial layer onto a predetermined position of a base material to form a coating film and then drying and/or curing the coating film to form an antibacterial film is preferable, and a method including a step of applying a composition for forming an antibacterial layer onto a predetermined position on a base material to form a coating film, a step of heating and drying the coating film, and a step of irradiating the coating film with ultraviolet rays and curing the coating film to form an antibacterial layer is more preferable.

The composition for forming an antibacterial layer contains at least antibacterial agent particles, a binder, and light diffusing particles. In a case where the binder is a polymer obtained by polymerizing a monomer, the composition for forming an antibacterial layer may contain at least antibacterial agent particles, monomers (for example, a hydrophilic monomer and a polyfunctional monomer), and light diffusing particles.

The composition for forming an antibacterial layer will be described later.

A method of applying the composition for forming an antibacterial layer onto the surface of the base material is not particularly limited, and a known coating method can be applied. Examples of the method of applying the composition for forming an antibacterial layer on the surface of the base material include a spraying method, a wire bar coating method, an extrusion coating method, a direct gravure coating method, a reverse gravure coating method, an inkjet method, a die coating method, an electrostatic painting method, and a wiping method.

The coating film formed on the surface of the base material according to the above-described coating method is dried and/or cured to form an antibacterial layer.

Examples of the method of removing a solvent from a coating film of the composition for forming an antibacterial layer to dry the coating film include heating treatment. The conditions for the heating treatment are not particularly limited; however, for example, the heating temperature is preferably 20° C. to 150° C. and more preferably 20° C. to 60° C. In addition, the heating time is preferably 15 to 600 seconds.

The coating film of the composition for forming an antibacterial layer containing a monomer may be cured by the exposure treatment to form an antibacterial layer. The exposure treatment at this time is not particularly limited; however, it is preferable to cure the coating film by irradiating it with an ultraviolet ray at an irradiation dose of 190 mJ/cm² or more. The upper limit of the irradiation dose is not particularly limited; however, it is preferably 600 mJ/cm² or less.

In the case of irradiation with ultraviolet rays, ultraviolet rays emitted from a light source of an ultrahigh pressure mercury lamp, a high pressure mercury lamp, a low pressure mercury lamp, a carbon arc, a xenon arc, a metal halide lamp, or the like be utilized.

<Composition for Forming Antibacterial Layer>

The composition for forming an antibacterial layer contains at least antibacterial agent particles, a binder or a monomer, and light diffusing particles.

The composition for forming an antibacterial layer may contain the above-described optional component contained in the antibacterial layer. The composition for forming an antibacterial layer preferably contains a solvent. In addition, in a case where the composition for forming an antibacterial layer contains a monomer, it preferably further contains a polymerization initiator. In a case where the composition for forming an antibacterial layer contains a polymerization initiator, the antibacterial layer containing a polymer has more excellent mechanical strength.

The components other than the solvent and the polymerization initiator are as described above, including the preferred aspects thereof.

(Solvent)

The solvent contained in the composition for forming an antibacterial layer is not particularly limited, and examples thereof include water and an organic solvent. Among the above, the solvent preferably contains an organic solvent from the viewpoint that the thickness of the coating film tends to be more uniform.

Examples of the organic solvent include an alcohol-based solvent, an ester-based solvent, a ketone-based solvent, and an ether-based solvent. More specific examples thereof include methanol, ethanol, acetone, methyl ethyl ketone, cyclohexane, ethyl acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetyl acetone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 3-methoxypropanol, methoxymethoxyethanol, diethylene glycol monomethyl ether, diethylene glycol monoethyl ether, diethylene glycol dimethyl ether, diethylene glycol diethyl ether, propylene glycol monomethyl ether acetate, n-propanol, isopropanol, n-butanol, 2-butanol, i-butanol, t-butanol, n-pentanol, t-amyl alcohol, n-hexanol, capryl alcohol, lauryl alcohol, myristyl alcohol, phenylethyl alcohol, ethylene glycol, ethylene glycol mono-n-butyl ether, diethylene glycol mono-n-butyl ether, triethylene glycol mono-n-butyl ether, tetraethylene glycol mono-n-butyl ether, and dipropylene glycol monobutyl ether.

The boiling point of the organic solvent is not particularly limited; however, it is preferably 70° C. to 160° C. and more preferably 80° C. to 150° C.

One kind of solvent may be used alone, or two or more kinds thereof may be used in combination. Among the above, it is preferable to use in combination two or more kinds of solvents having characteristics different from each other, and it is more preferable to use in combination three or more kinds of solvents having characteristics different from each other.

Examples of the above-described characteristics include a boiling point, a chemical structure, and polarity. That is, as the solvent, it is preferable to use in combination two or more kinds of solvents having boiling points different from each other, and it is more preferable to use in combination three or more kinds of solvents having boiling points different from each other. In addition, it is preferable to use in combination two or more kinds of solvents selected from the group consisting of an alcohol-based solvent, an ester-based solvent, a ketone-based solvent, and an ether-based solvent.

In a case of using in combination solvents having characteristics different from each other as described above and selecting a ratio between solvents according to the kind of the raw material as the solid content, the coating method, the drying method, and the like, it is possible to control the surface characteristics of the antibacterial layer.

The content of the solid content in the composition for forming an antibacterial layer, that is, the total content of the components other than the solvent is not particularly limited; however, it is preferably 1% to 50% by mass with respect to the total mass of the composition for forming an antibacterial layer from the viewpoint that it is easy to form a coating film having a more uniform thickness.

The polymerization initiator is not particularly limited, and any known polymerization initiator can be used. Examples of the polymerization initiator include a thermal polymerization initiator and a photopolymerization initiator, where a photopolymerization initiator is preferable from the viewpoint of excellent reaction efficiency.

Examples of the polymerization initiator include aromatic ketones such as benzophenone and phenylphosphine oxide; α-hydroxyalkylphenone-based compounds (manufactured by BASF SE, IRGACURE (Omnirad) 184, 127, and 2959, DAROCUR 1173, and the like); and phenylphosphine oxide-based compounds (monoacylphosphine oxide: IRGACURE (Omnirad) TPO manufactured by BASF SE and bisacylphosphine oxide: IRGACURE (Omnirad) 819 manufactured by BASF SE).

One kind of polymerization initiator may be used alone, or two or more kinds thereof may be used in combination.

In a case where the composition for forming an antibacterial layer contains a polymerization initiator, the content of the polymerization initiator is not particularly limited; however, it is preferably 0.1% to 15% by mass and more preferably 1% to 6% by mass with respect to the content of the monomer.

The composition for forming an antibacterial layer can be prepared by mixing the above components. The order of mixing the above-described components is not particularly limited. However, in a case where the composition for forming an antibacterial layer contains a dispersing agent, the antibacterial agent particles and the dispersing agent may be mixed first to prepare a dispersion liquid in which the antibacterial agent particles are dispersed.

[Physical Properties of Antibacterial Film]

<Condition 1>

As described above, the present antibacterial film satisfies the specific condition 1 that the specific haze ratio (|Ha−Hb|/Hc) calculated from the haze Ha in a wavelength range of 380 to 570 nm, the haze Hb in a wavelength range of more than 570 nm and 750 nm or less, and the haze Hc in a wavelength range of 380 nm to 750 nm is in a range of 0 to 0.15.

The haze Ha, the haze Hb, and the haze Hc of the antibacterial film can be determined by measuring the transmittance of light transmitted through the antibacterial film using a spectrophotometer (for example, “VAP-7070” manufactured by JASCO Corporation) equipped with an integrating sphere unit.

More specifically, in each wavelength region, the antibacterial film and the integrating sphere unit are disposed at close positions to measure the omnidirectional transmittance (τs) of the antibacterial film, and the specimen and the integrating sphere unit are disposed at positions spaced apart from each other to measure the rectilinear transmittance (τl) of the antibacterial film. Next, the haze (%) at the measurement wavelength is calculated from the measured omnidirectional transmittance TS and the rectilinear transmittance τl by using the expression of (τs−τl)×100/τs. From the obtained haze at each measurement wavelength, an average value Ha (%) of hazes in a wavelength range of 380 to 570 nm, an average value Hb (%) of hazes in a wavelength range of more than 570 nm and 750 nm or less, and an average value Hc (%) of hazes in a wavelength range of 380 to 750 nm are obtained.

The measurement of the transmittance may be carried out over the entire range of each wavelength region or may be carried out every 1 to 10 nm (preferably every 5 nm) in each wavelength region.

In addition, before measuring the transmittance, the spectrophotometer is calibrated by measuring the transmittance without installing the antibacterial film.

The specific haze ratio of the antibacterial film is preferably 0 to 0.14 and more preferably 0 to 0.13 from the viewpoint that the effect of the present invention is more excellent.

The specific haze ratio of the antibacterial film can be adjusted, for example, by changing the content of the light diffusing particle described below and/or the thickness of the antibacterial layer.

<Condition 2>

It is preferable that the antibacterial film satisfies the following condition 2 in addition to the above condition 1.

The Condition 2:

Using a spectrophotometer equipped with an integrating sphere unit, the omnidirectional transmittance τs and the rectilinear transmittance τl in a wavelength range of 380 to 750 nm are measured. From the measured omnidirectional transmittance TS and rectilinear transmittance τl, tristimulus values (τs (X), τs (Y), τs (Z)) of the omnidirectional transmittance in an XYZ display system and tristimulus values (τl (X), τl (Y), τl (Z)) of the rectilinear transmittance are determined according to a method in accordance with JIS-Z-8722. Next, tristimulus values of a haze of H (Z), H (Y), and H (X) are calculated using the following Expressions (I), (II), and (III), respectively.

Each of the ratio of H (Z) to H (Y) (H (Z)/H (Y)) and the ratio of H (Z) to H (X) (H (Z)/H (X)), which are determined from the calculated H (Z), H (Y), and H (X), is 1.0 to 1.2.

H(Z)=(τs(Z)−τl(Z))/τl(Z) (I)

H(Y)=(τs(Y)−τl(Y))/τl(Y) (II)

H(X)=(τs(X)−τl(X))/τl(X) (III)

The method of measuring the omnidirectional transmittance τs and the rectilinear transmittance τl in a wavelength range of 380 to 750 nm by using a spectrophotometer equipped with an integrating sphere unit may be the same as the above-described measurement method for the hazes Ha, Hb, and Hc.

Here, H (X) indicates a haze of red light, H (Y) indicates a haze of green light, H (Z) indicates a haze of blue light, an H (Z)/H (X) value indicates a ratio of the haze of blue light to the haze of red light, and an H (Z)/H (Y) value indicates a ratio of the haze of blue light to the haze of green light. That is, it is indicated that in a case where the value of H (Z)/H (X) is large, the diffusion of blue light is stronger than the diffusion of red light, and in a case where the value of H (Z)/H (Y) is large, the diffusion of blue light is stronger than the diffusion of green light.

In a case where the antibacterial film satisfies the above condition 2, the tint reproducibility of the antibacterial film is improved. Here, “the tint reproducibility is improved” means that the difference between the tint of the display image in a case where the antibacterial film is disposed on the surface of the display and the tint of the display image in a case where the antibacterial film is not used is further reduced.

From the viewpoint that the tint of the antibacterial film is more excellent, both H (Z)/H (Y) and H (Z)/H (X) are preferably 1.0 to 1.2 and more preferably 1.0 to 1.15.

The tristimulus values H (X), H (Y), and H (Z) of the haze of the antibacterial film can be adjusted, for example, by changing the content of the light diffusing particle and/or the thickness of the antibacterial layer to adjust the tristimulus values of the omnidirectional transmittance and the rectilinear transmittance.

<Haze>

The haze Hc in the wavelength range of 380 to 750 nm of the antibacterial film is not particularly limited; however, it is preferably 17% or more, more preferably 20% or more, and still more preferably 23% or more, from the viewpoint of being more excellent in antiglare properties. The upper limit thereof is not particularly limited; however, it is 40% or less in many cases.

The measuring method for the haze Hc in a wavelength range of 380 to 750 nm is as described above.

<Surface Roughness>

The arithmetic average roughness Ra of the surface of the antibacterial layer of the antibacterial film is preferably 0.05 to 10 μm, more preferably 0.1 to 10 μm, and still more preferably 0.5 to 10 μm. In a case where the arithmetic average roughness Ra of the surface of the antibacterial layer is within the above range, the finger sliding properties of the surface of the antibacterial film can be improved, the operability in a case where the antibacterial layer is attached to the touch panel can be improved, and the antiglare function can be also improved.

The arithmetic average roughness Ra of the surface of the antibacterial layer can be measured by analyzing a 10 μm square shape of the surface of the antibacterial layer using a laser microscope (for example, “VK-9500” manufactured by KEYENCE CORPORATION) in accordance with JIS B 0601: 1994.

[Use Application Antibacterial Film of Antibacterial Film]

The present antibacterial film can be applied to various use applications. For example, by disposing the antibacterial film on the surface of various articles, antibacterial properties can be imparted to a surface of an article. In addition, the present antibacterial film can be disposed on a surface of a transparent base material of a device such as a display and used as an antiglare and antibacterial film having excellent image visibility.

In particular, it is preferable to dispose the present antibacterial film on a surface of an image display unit of the touch panel to manufacture a touch panel attached with the antibacterial film. Due to the present antibacterial film, even in a situation where a finger or the like frequently comes into contact by a touch panel operation or the like, good antibacterial properties can be exhibited, good antiglare properties can be exhibited, and image visibility can also be improved.

The use application of the touch panel attached with the antibacterial film is not particularly limited, and it can be used as an input device and an image display device in an electronic device, for example, a personal computer, a cellular phone, a game machine, a medical device, an automatic teller machine (ATM), an ordering device, a ticket vending machine, a copying machine, or a car navigation system.

In addition, the present antibacterial film can be used as a face guard having an antibacterial function or a partition plate. Further, the present antibacterial film can also be used by being attached to a wall, a window glass, or the like.

### EXAMPLES

Hereinafter, the present invention will be described in more detail based on Examples. The materials, the using amounts of materials, the proportions, the treatment details, the treatment procedure, and the like shown in Examples below may be appropriately modified as long as the modifications do not depart from the spirit of the present invention. Accordingly, the scope of the present invention should not be construed as being limited to Examples shown below.

### Example 1

[Preparation of Composition for Forming Antibacterial Layer]

The following components were mixed in a container, and the obtained mixed solution was stirred to prepare a composition for forming an antibacterial layer (a composition A-1). The concentration of solid contents of the composition A-1 was 26.0% by mass.
Monomer 1: 13.6 parts by mass of “DPHA-76” manufactured by Toshin Yushi Co., Ltd. (dipentaerythritol hexaacrylate, a polyfunctional monomer, solid content: 76% by mass)
Monomer 2: 10.4 parts by mass of “KAYARAD PET-30” manufactured by Nippon Kayaku Co., Ltd. (a mixture of pentaerythritol triacrylate and pentaerythritol tetraacrylate, a polyfunctional monomer)
Monomer 3: 1.3 parts by mass of “NK ESTER A-GLY-9E” manufactured by SHIN-NAKAMURA CHEMICAL Co., Ltd. (glycerin triacrylate modified with 9 moles of ethylene oxide, a hydrophilic monomer represented by Formula (A))
Antibacterial agent particle: 0.7 parts by mass of zirconium phosphate-based silver-based antibacterial agent (manufactured by Fuji Chemical Industries, Ltd., average particle diameter: 1.0 μm, silver content: 3.7% by mass, a zirconium phosphate-based carrier)
Light diffusing particle: 2.0 parts by mass of “MX-300” manufactured by Soken Chemical & Engineering Co., Ltd. (an acrylic resin particle, average particle diameter: 3.0 μm)
Polymerization initiator: 0.7 parts by mass of “IRGACURE (Omnirad) 184” manufactured by BASF SE
Dispersing agent: 3.3 parts by mass of “DISPERBYK-180” manufactured by BYK Additives & Instruments
Surfactant: 0.3 parts by mass of “X-71-1203E” manufactured by Shin-Etsu Chemical Co., Ltd. (a urethane acrylate-based fluororesin composed of 2-isocyanate ethyl acrylate and ethylene glycol, solid content: 20% by mass)
Solvent 1: 22.1 parts by mass of isopropyl alcohol
Solvent 2: 23.1 parts by mass of 1-methoxy-2-propylacetate
Solvent 3: 25.2 parts by mass of 1-methoxy-2-propanol

[Manufacture of Antibacterial Film]

The composition A-1 was applied onto a surface of a polyethylene terephthalate (PET) base material (manufactured by FUJIFILM Corporation) having a thickness of 100 μm, which was obtained by laminating an easy adhesion layer, on a side of the easy adhesion layer. Next, the coating film was heated at 60° C. for 2 minutes and dried, and then the coating film was irradiated with ultraviolet rays at an irradiation dose of 290 mJ/cm² to cure the monomer, thereby forming an antibacterial layer B-1. The thickness of the formed antibacterial layer B-1 was 2.5 μm.

In addition, the contents of the binder (a hydrophilic polymer obtained by polymerizing the monomer 1, the monomer 2, and the monomer 3), in the antibacterial layer B-1, the antibacterial agent particle, and the light diffusing particle were respectively 76.5% by mass, 2.4% by mass, and 7.0% by mass with respect to the total mass of the antibacterial layer B-1.

It is noted that the PET base material was prepared according to the description of Example in JP2015-163457A. The arithmetic average roughness Ra and the maximum height Rz of the surface of the prepared PET base material were measured using a laser microscope (“VK-X1000” manufactured by KEYENCE CORPORATION) according to a method in accordance with ISO 4287. The arithmetic average roughness Ra of the surface of the PET base material was 0.013 μm, and the ratio (Rz/Ra) of the maximum height Rz to the arithmetic average roughness Ra was 15.3.

The thickness of the antibacterial layer was obtained by embedding the antibacterial film in a resin, cutting out a cross section with a microtome, observing the cut-out cross section with a scanning electron microscope to measure thicknesses at any 10 positions of the antibacterial layer in the obtained observation image according to the above-described method, and arithmetically averaging the measured values. In the following Examples and Comparative Examples, the thickness of the antibacterial layer was measured according to the same method.

### Comparative Example 1

As the antibacterial film of Comparative Example 1, “M20E-CPF-100 (75)-SL50-AB” (an antiglare and antibacterial film) manufactured by NIPPA Co., Ltd. was used. As will be described later, the antibacterial film of Comparative Example 1 has a specific haze ratio of 0.19 and does not satisfy the condition 1. In addition, the thickness of the antibacterial layer of the antibacterial film of Comparative Example 1 was 1.9 μm, and the thickness of the base material was 100 μm.

[Measurement and Evaluation]

[Measurement of Optical Characteristics]

The optical characteristics of the antibacterial films of Examples 1 and Comparative Example 1 were evaluated by the following method.

The transmittance of light transmitted through the specimen of each antibacterial film was measured using a spectrophotometer (“VAP-7070” manufactured by JASCO Corporation) equipped with an integrating sphere unit. At this time, the specimen and the integrating sphere unit were disposed at close positions to measure the omnidirectional transmittance (τs) of the specimen, and the specimen and the integrating sphere unit were disposed at positions spaced art from each other to measure the rectilinear transmittance (τl) of the specimen.

The measurement of each transmittance was carried out every 5 nm in a measurement wavelength range of 380 to 750 nm. In addition, before measuring each transmittance, the spectrophotometer was calibrated by measuring the transmittance without installing the specimen of the antibacterial film.

From the omnidirectional transmittance τs and the rectilinear transmittance τl at each wavelength, the haze (%) at each wavelength was calculated using the expression of (τs−τl)×100/τs. From the obtained haze at each wavelength, the haze Ha (%) at a wavelength of 380 to 570 nm, the haze Hb (%) at a wavelength of more than 570 nm and 750 nm or less, and the haze Hc (%) at a wavelength of 380 to 750 nm were calculated.

From each of the obtained haze values, the specific haze ratio was calculated using the expression of “|Ha−Hb|/Hc”.

In a case where the specific haze ratio of the antibacterial film is in a range of 0 to 0.15, the antibacterial film satisfies the condition 1.

In addition, from the omnidirectional transmittance τs and rectilinear transmittance τl at each wavelength, tristimulus values in an XYZ display system were calculated according to a method in accordance with JIS-Z-8722, and then tristimulus values (τs (X), τs (Y), τs (Z)) of the omnidirectional transmittance and tristimulus values τl (X), τl (Y), τl (Z)) of the rectilinear transmittance were determined. From the obtained tristimulus values of the omnidirectional transmittance TS and the rectilinear transmittance τl, the tristimulus values of haze were calculated using Expressions (I) to (III) below.

H(Z)=(τs(Z)−τl(Z))/τl(Z) (I)

H(Y)=(τs(Y)−τl(Y))/τl(Y) (II)

H(X)=(τs(X)−τl(X))/τl(X) (III)

Next, from the calculated tristimulus values of the haze, a ratio (H (Z)/H (X)) of H (Z) to H (X) and a ratio (H (Z)/H (Y)) of H (Z) to H (Y) were calculated.

The measurement results of the optical characteristics obtained from the antibacterial film of each of Examples and Comparative Examples are shown in Table 1 described later.

[Evaluation of Antibacterial Properties]

The antibacterial properties of the surface of the antibacterial layer were measured by the following method in accordance with the evaluation method described in JIS Z 2801: 2010.

An antibacterial film having an antibacterial layer of each of Examples and Comparative Examples was cut into a square of 50 mm square, and a test piece having the cut antibacterial layer was disposed in a sterile petri dish to prepare a specimen. The surface of the antibacterial layer of the prepared test piece was inoculated with 0.4 ml of an Escherichia coli solution prepared to have a bacterial count of 2.5×10⁵ to 10×10⁵ cells/ml, and the Escherichia coli cells were cultured in an incubator at a temperature of 35° C. and a relative humidity of 90%. The antibacterial properties were evaluated from the antibacterial activity values of each test piece, measured after culturing for 3 hours and 24 hours, according to the following standards.

(Evaluation Standard for Antibacterial Properties)

“A”: The antibacterial activity value is 3.5 or more.

“B”: The antibacterial activity value is 2.0 or more and less than 3.5.

“C”: The antibacterial activity value is 1.0 or more and less than 2.0.

“D”: The antibacterial activity value is less than 1.0.

[Evaluation of Antiglare Function]

A fluorescent lamp, placed to be spaced apart from the antibacterial film by a distance of 2.5 m, was projected onto the antibacterial film of each of Examples and Comparative Examples, and the antiglare function of the antibacterial film was evaluated according to the following standards based on the blurring of the outline of the fluorescent lamp.

“A”: The outline of the fluorescent lamp is blurred.

“B”: The outline of the fluorescent lamp is slightly blurred.

“C”: The outline of the fluorescent lamp is sharp.

[Evaluation of Image Visibility and Tint]

Next, the visibility and the tint of the display image in a case where the antibacterial film manufactured in each of Examples and Comparative Examples had been provided in the display device were visually evaluated based on the following standards.

The antibacterial film manufactured in each of Examples and Comparative Examples was attached to a surface of a tablet terminal (“iPhone (registered trade name) SE” manufactured by Apple Inc.) and laminated. The brightness uniformity of the display image observed through each of the antibacterial films was visually evaluated based on the following standards from the observation results obtained when being observed at a distance of 30 cm from the front surface (in the normal direction of the display surface). In addition, the tint of the display image was visually evaluated based on the following standards. It is noted that each evaluation of the display image was carried out in a dark room. The evaluation results are shown in Table 1 described later.

(Evaluation Standard for Visibility (Brightness Uniformity))

“A”: The brightness of the display image was very uniform as a whole.

“B”: The brightness of the display image was uniform as a whole.

“C”: There were regions where the brightness was different depending on the position of the display image.

“D”: The brightness was clearly different depending on the position of the display image and was non-uniform as a whole.

(Evaluation Standards for Tint of Image)

“A”: The tint reproducibility of the display image was very high.

“B”: The tint reproducibility of the display image was high.

“C”: The display image had strong blueness, and the tint reproducibility was low.

“D”: The display image had particularly strong blueness, and the tint reproducibility was very low.

[Measurement of Surface Roughness]

The arithmetic average roughness Ra of the surface of the antibacterial layer was measured in accordance with JIS B 0601: 1994. The shape of the surface of the antibacterial layer, in a 10 μm square, was analyzed using a laser microscope (“VK-9500” manufactured by KEYENCE CORPORATION), and the arithmetic average roughness Ra was determined by a general-purpose program attached to this apparatus.

[Evaluation of Finger Sliding Properties]

The finger sliding properties of the antibacterial film manufactured in each of Examples and Comparative Examples were evaluated by carrying out a sensory test of placing a tester's finger on the antibacterial film, rubbing it just beside the finger by 60 mm, and checking the presence or absence of a feeling of being caught. The finger sliding properties of the antibacterial film were evaluated based on the following standards. The evaluation results are shown in Table 1 described later.

(Evaluation Standard for Finger Sliding Properties)

“A”: There was no feeling of being caught.

“B”: There was a feeling of being caught.

Table 1 below shows the configurations, measurement results, and evaluation results of the antibacterial films manufactured in Example 1 and Comparative Example 1.

TABLE 1

| | Antibacterial film | | | | | | | | | | |
|---|---|---|---|---|---|---|---|---|---|---|---|
| | Optical characteristics | | | | Arithmetic | Evaluation | | | | | |
| | Haze | | | | average | Antibacterial properties | | | | | Finger |
| | Hc | Specific | H (Z)/ | H (Z)/ | roughness | After 3 | After 24 | | Image | | sliding |
| | (%) | haze ratio | H (Y) | H (X) | Ra (μm) | hours | hours | Antiglare | visibility | Tint | properties |
| Example 1 | 27 | 0.13 | 1.05 | 1.05 | 0.65 | A | A | A | A | A | A |
| Comparative | 22% | 0.19 | 1.12 | 1.13 | — | A | A | A | D | B | A |
| Example 1 | | | | | | | | | | | |

From the results shown in Table 1, it has been confirmed that the antibacterial film of Example 1 in which the specific haze ratio is 0.15 or less has excellent image visibility as compared with Comparative Example 1.

### Examples 2 to 12 and Comparative Examples 2 and 3

Compositions A-2 to A-11 were prepared according to the method described in [Preparation of composition for forming antibacterial layer] of Example 1, except that the respective components were mixed so that the compositions shown in Table 2 below were obtained.

Each numerical value shown in Table 2 indicates the content (unit: part by mass) of the component described in the corresponding column.

TABLE 2

| | Composition (part) | | | | | | | | | | |
|---|---|---|---|---|---|---|---|---|---|---|---|
| | Hydrophilic monomer | | | | Light | Polymer- | | | Solvent | | |
| | Monomer | Monomer | Monomer | Antibacterial | diffusing | ization | Dispersing | | Solvent | Solvent | Solvent |
| | 1 | 2 | 3 | agent particle | particle | initiator | agent | Surfactant | 1 | 2 | 3 |
| Composition A-1 | 13.6 | 10.4 | 1.3 | 0.7 | 2.0 | 0.7 | 3.3 | 0.3 | 22.1 | 23.1 | 25.2 |
| Composition A-2 | 6.8 | 5.2 | 0.7 | 0.7 | 0.2 | 0.7 | 3.3 | 0.3 | 22.1 | 23.1 | 25.2 |
| Composition A-3 | 13.6 | 10.4 | 1.3 | 0.7 | 4.0 | 0.7 | 3.3 | 0.3 | 22.1 | 23.1 | 25.2 |
| Composition A-4 | 13.6 | 10.4 | 1.3 | 0.7 | 1.0 | 0.7 | 3.3 | 0.3 | 22.1 | 23.1 | 25.2 |
| Composition A-5 | 13.6 | 10.4 | 1.3 | 5.5 | 2.0 | 0.7 | 3.3 | 0.3 | 22.1 | 23.1 | 25.2 |
| Composition A-6 | 13.0 | 10.4 | 1.3 | 0.7 | 2.0 | 0.4 | 3.3 | 0.3 | 22.1 | 23.1 | 25.2 |
| Composition A-7 | 10.0 | 10.4 | 4.9 | 0.7 | 2.0 | 0.7 | 3.3 | 0.3 | 22.1 | 23.1 | 25.2 |
| Composition A-8 | 10.4 | 13.6 | 1.3 | 0.7 | 2.0 | 0.7 | 3.3 | 0.3 | 22.1 | 23.1 | 25.2 |
| Composition A-9 | 13.6 | 11.7 | — | 0.7 | 2.0 | 0.7 | 3.3 | 0.3 | 22.1 | 23.3 | 25.2 |
| Composition A-10 | 13.6 | 10.4 | 1.3 | 6.0 | 2.0 | 0.7 | 3.3 | 0.3 | 22.1 | 23.1 | 25.2 |
| Composition A-11 | 13.6 | 10.4 | 1.3 | 0.7 | 8.0 | 0.7 | 3.3 | 0.3 | 22.1 | 23.1 | 25.2 |

Next, antibacterial films including a base material and an antibacterial layer were manufactured according to the method described in [Manufacture of antibacterial film] of Example 1, except that the base material to be used, the composition to be used for forming the antibacterial layer, and the formation conditions for the antibacterial layer (the drying temperature of the coating film and the irradiation dose of the ultraviolet ray) were as described in Table 3 below.

Each of the manufactured antibacterial films was subjected to the measurement and the evaluation of the characteristics of the antibacterial film according to the same method as in Example 1.

### Example 13

A composition A-12 was prepared according to the method described in [Preparation of composition for forming antibacterial layer] of Example 1, except that 3.3 parts by mass of “AJISPER PB881” manufactured by Ajinomoto Fine-Techno Co., Inc. was used instead of “DISPERBYK-180” as a dispersing agent. Using the obtained composition A-12, antibacterial films including a base material and an antibacterial layer were manufactured according to the method described in [Manufacture of antibacterial film] of Example 1.

Each of the manufactured antibacterial films was subjected to the measurement and the evaluation of the characteristics of the antibacterial film according to the same method as in Example 1.

Regarding the antibacterial films manufactured in Examples 2 to 13 and Comparative Examples 2 and 3, Table 3 shows the used base material, the used composition for forming an antibacterial layer, the formation conditions for the antibacterial layer, the composition of the formed antibacterial layer, and the measurement results, as well as the evaluation results of respective characteristics, are shown together with each result of Example 1.

In the table, the column of “Material” of “Base material” indicates a material constituting the base material, “PC” indicates a polycarbonate base material having a thickness of 100 μm (“PURE-ACE” manufactured by TEIJIN LIMITED), and “TAC” indicates a triacetyl cellulose base material having a thickness of 100 μm (“Fujitac” manufactured by FUJIFILM Corporation). In addition, in the column of “Arithmetic average roughness Ra” and the column of “Rz/Ra” of “Base material”, the arithmetic average roughness Ra of the surface of the base material, which is measured according to the method described in Example 1, and the ratio (Rz/Ra) of the maximum height Rz to the arithmetic average roughness Ra are respectively shown.

In the table, in the column of “Binder”, the column of “Antibacterial agent particle”, and the column of “Light diffusing particle” of “Antibacterial layer”, the content ratios (% by mass) of the binder, the antibacterial agent particle, and the light diffusing particle with respect to the total mass of each antibacterial layer are respectively shown. In addition, the column of “Amount of applied silver mg/m²” in the table indicates the content of silver contained in the antibacterial agent particle per area of the antibacterial layer.

TABLE 3

| | Base material | | | Antibacterial layer | | | | | | |
|---|---|---|---|---|---|---|---|---|---|---|
| | | Arithmetic | | | Formation condition | | Composition [%] | | | |
| | | average | | | | UV | | | Light | Amount of |
| | | roughness | Rz/ | | Drying | irradiation | | Antibacterial | diffusing | applied silver |
| | Material | Ra (μm) | Ra | Composition | temperature | dose | Binder | agent particle | particle | mg/m² |
| Example 1 | PET | 0.013 | 15.3 | A-1 | 60° C. | 290 mJ | 76.5 | 2.4 | 7.0 | 3.4 |
| Example 2 | PET | 0.013 | 15.3 | A-2 | 60° C. | 290 mJ | 69.0 | 4.4 | 1.25 | 6.2 |
| Example 3 | PET | 0.013 | 15.3 | A-3 | 60° C. | 290 mJ | 71.6 | 2.3 | 1.30 | 3.3 |
| Example 4 | PET | 0.013 | 15.3 | A-4 | 60° C. | 290 mJ | 79.3 | 2.5 | 3.6 | 3.5 |
| Example 5 | PET | 0.013 | 15.3 | A-5 | 60° C. | 290 mJ | 65.6 | 16.4 | 6.0 | 23.2 |
| Example 6 | PC | 0.010 | 10.2 | A-1 | 60° C. | 290 mJ | 76.5 | 2.4 | 6.9 | 3.4 |
| Example 7 | TAC | 0.014 | 16.7 | A-1 | 60° C. | 290 mJ | 76.5 | 2.4 | 6.9 | 3.4 |
| Example 8 | PET | 0.013 | 15.3 | A-6 | 30° C. | 290 mJ | 77.3 | 2.5 | 7.0 | 3.5 |
| Example 9 | PET | 0.013 | 15.3 | A-1 | 60° C. | 200 mJ | 76.5 | 2.4 | 6.9 | 3.4 |
| Example 10 | PET | 0.013 | 15.3 | A-7 | 60° C. | 290 mJ | 77.2 | 2.4 | 6.7 | 3.4 |
| Example 11 | PET | 0.013 | 15.3 | A-8 | 60° C. | 290 mJ | 77.1 | 2.4 | 6.8 | 3.4 |
| Example 12 | PET | 0.013 | 15.3 | A-9 | 60° C. | 290 mJ | 76.5 | 2.4 | 6.9 | 3.4 |
| Example 13 | PET | 0.013 | 15.3 | A-12 | 60° C. | 290 mJ | 76.5 | 2.4 | 7.0 | 3.4 |
| Comparative | PET | 0.013 | 15.3 | A-10 | 60° C. | 290 mJ | 64.6 | 17.6 | 5.9 | 24.9 |
| Example 1 | | | | | | | | | | |
| Comparative | PET | 0.013 | 15.3 | A-11 | 80° C. | 290 mJ | 63.3 | 2.0 | 23.0 | 2.8 |
| Example 2 | | | | | | | | | | |

TABLE 4

| | Antibacterial film | | | | | | | | | | |
|---|---|---|---|---|---|---|---|---|---|---|---|
| | Optical characteristics | | | | Arithmetic | Evaluation | | | | | |
| | Haze | | | | average | Antibacterial properties | | | | | Finger |
| | Hc | Specific | H (Z)/ | H (Z)/ | roughness | After 3 | After 24 | | Image | | sliding |
| | (%) | haze ratio | H (Y) | H (X) | Ra (μm) | hours | hours | Antiglare | visibility | Tint | properties |
| Example 1 | 27 | 0.13 | 1.05 | 1.05 | 0.65 | A | A | A | A | A | A |
| Example 2 | 21 | 0.15 | 1.15 | 1.11 | 0.55 | A | A | A | B | B | A |
| Example 3 | 36 | 0.15 | 1.19 | 1.16 | 0.80 | A | A | A | B | B | A |
| Example 4 | 22 | 0.05 | 1.02 | 1.02 | 0.50 | A | A | A | A | A | A |
| Example 5 | 35 | 0.15 | 1.20 | 1.18 | 0.75 | A | A | A | B | B | A |
| Example 6 | 31 | 0.14 | 1.09 | 1.08 | 0.65 | A | A | A | B | B | A |
| Example 7 | 22 | 0.14 | 1.02 | 1.02 | 0.65 | A | A | B | A | A | A |
| Example 8 | 27 | 0.13 | 1.05 | 1.05 | 0.65 | A | A | A | A | A | A |
| Example 9 | 27 | 0.13 | 1.05 | 1.05 | 0.65 | A | A | A | A | A | A |
| Example 10 | 25 | 0.12 | 1.05 | 1.04 | 0.65 | A | A | A | A | A | A |
| Example 11 | 24 | 0.13 | 1.04 | 1.05 | 0.65 | A | A | A | A | A | A |
| Example 12 | 27 | 0.13 | 1.05 | 1.05 | 0.65 | A | A | A | A | A | A |
| Example 13 | 26 | 0.13 | 1.05 | 1.05 | 0.64 | A | A | A | A | A | A |
| Comparative | 50 | 0.22 | 1.20 | 1.28 | 1.15 | A | A | A | D | C | B |
| Example 2 | | | | | | | | | | | |
| Comparative | 48 | 0.20 | 1.22 | 1.08 | 1.35 | A | A | A | D | D | B |
| Example 3 | | | | | | | | | | | |

From the results shown in Table 3, it can be seen that in a case where the antibacterial film according to the embodiment of the present invention in which the specific haze ratio is in a range of 0 to 0.15 and satisfies the above condition 1, it has an antiglare function and is excellent in image visibility.

It has been confirmed that in a case where the content of the light diffusing particle was 20% by mass or less with respect to the total mass of the antibacterial layer, the image visibility and the tint are more excellent (see Examples 1 and 3 and Comparative Example 3). However, in a case where the content of the antibacterial agent particles is 17% by mass or more with respect to the total mass of the antibacterial layer, the image visibility and the tint are impaired even in a case where the above conditions are satisfied.

Further, it has been confirmed that in a case where the content of the light diffusing particles is 1.3% by mass or more with respect to the total mass of the antibacterial layer, the antiglare function is more excellent (see Examples 1 and 2).

Further, it has been confirmed that in a case where the content of the light diffusing particle is 1.3% by mass or more with respect to the total mass of the antibacterial layer and the content of the binder is 65% by mass or more with respect to the total mass of the antibacterial layer, the image visibility and the tint are more excellent (see Examples 1, 2, and 4).

In addition, it has been confirmed that an antibacterial film exhibiting the same effect can be manufactured even in a case where the kind of the base material and the formation conditions for the antibacterial layer are changed (see Examples 1 and 6 to 9).

### Examples 14 to 16

An antibacterial film of Example 14 was manufactured according to the method described in Example 1, except that as the antibacterial agent particle, the zirconium phosphate-based silver-based antibacterial agent was replaced with the same amount of the copper-based antibacterial agent (“IMADEZE” manufactured by KOKEN Ltd.).

An antibacterial film of Example 15 was manufactured according to the method described in Example 1, except that as the polymerization initiator, “IRGACURE (Omnirad) 184” manufactured by BASF SE was replaced with the same amount of “IRGACURE (Omnirad) 981” manufactured by BASF SE.

Further, an antibacterial film of Example 16 was manufactured according to the method described in Example 1, except that as the light diffusing particle, “MX-300” manufactured by Soken Chemical & Engineering Co., Ltd. was replaced with the same amount of “SSX-103” (average particle diameter: 3 μm) manufactured by Sekisui Chemical Company, Limited.

As a result of subjecting the antibacterial films of Examples 14 to 16 to the measurement and the evaluation of the characteristics of the antibacterial films according to the same method as in Example 1, it has been confirmed that all of the antibacterial films of Examples 14 to 16 satisfy the above condition 1 and the same evaluation results as those in Example 1 are obtained in terms of antibacterial properties, antiglare function, image visibility, tint, and finger sliding properties.

(Evaluation of Antiviral Properties)

The antibacterial films shown in Table 3 were subjected to the evaluation test based on the evaluation test method for the antiviral activity of plastics, defined by ISO 21702. A type A influenza virus was used as a test virus, and the anti-influenza viral properties were evaluated.

0.4 mL of a virus solution having a concentration adjusted to 1.6×10⁷ PFU/mL was dropped onto the surface of each of the antibacterial films of Examples 1 to 5, and the infection titer (At) (PFU/cm²) at 25° C. after being allowed to stand for 24 hours after the dropping was measured. Similarly, the above-described virus solution was dropped onto a surface of an unprocessed PET film, and the infection titer (Ut) (PFU/cm²) after 24 hours was measured. The antiviral activity value R was calculated, according to the expression of R=log₁₀(Ut)−log₁₀(At), from the infection titer (At) when each antibacterial film was used and the infection titer (Ut) when the unprocessed film was used.

The antibacterial films shown in Table 3 were subjected to the antiviral property test in the same manner except that a novel coronavirus was used instead of the type A influenza virus, whereby the anti-novel coronaviral properties were evaluated.

Table 4 shows the evaluation results of the anti-influenza viral properties and the anti-novel coronaviral properties.

TABLE 4

| | Evaluation | |
|---|---|---|
| | Anti-influenza | Anti-new type |
| | viral properties | coronaviral properties |
| Example 1 | 2.3 | 2.1 |
| Example 2 | 3.4 | 2.8 |
| Example 3 | 2.4 | 2.1 |
| Example 4 | 2.2 | 2.1 |
| Example 5 | 3.8 | 2.5 |
| Example 6 | 2.3 | 2.2 |
| Example 7 | 2.2 | 2.1 |
| Example 8 | 2.3 | 2.2 |
| Example 9 | 2.3 | 2.2 |
| Example 10 | 2.3 | 2.2 |
| Example 11 | 2.3 | 2.2 |
| Example 12 | 2.3 | 2.2 |
| Example 13 | 2.3 | 2.2 |
| Comparative Example 2 | 2.8 | 2.4 |
| Comparative Example 3 | 1.4 | 1.2 |

From the results shown in Table 4, it can be seen that in a case where the antibacterial film according to the embodiment of the present invention in which the specific haze ratio is in a range of 0 to 0.15 and satisfies the above condition 1, it has an antiglare function, is excellent in image visibility, and has antiviral properties.

### EXPLANATION OF REFERENCES

101: base material
102: antibacterial layer
110: antibacterial film

What is claimed is:

1. An antibacterial film comprising:
a base material; and
at least one antibacterial layer disposed on the base material,
wherein the antibacterial layer contains a binder, a light diffusing particle, and an antibacterial agent particle, and
the antibacterial film satisfies the following condition 1,
the condition 1:
an average value Ha of hazes of the antibacterial film in a wavelength range of 380 to 570 nm, an average value Hb of hazes of the antibacterial film in a wavelength range of more than 570 nm and 750 nm or less, and an average value Hc of hazes of the antibacterial film in a wavelength range of 380 to 750 nm satisfy Expression (1),
0≤|Ha−Hb|/Hc≤0.15 (1).

2. The antibacterial film according to claim 1,
wherein the antibacterial film further satisfies the following condition 2,
the condition 2:
in a case where an omnidirectional transmittance τs and a rectilinear transmittance τl of light that transmits through the antibacterial film are measured in a wavelength range of 380 to 750 nm using a spectrophotometer equipped with an integrating sphere unit, tristimulus values (τs (X), τs (Y), τs (Z)) of the omnidirectional transmittance in an XYZ display system and tri stimulus values (τl (X), τl (Y), τl (Z)) of the rectilinear transmittance are determined from the measured omnidirectional transmittance τs and rectilinear transmittance τl according to a method in accordance with JIS-Z-8722, and H (Z), H (Y), and H (X) are subsequently calculated respectively using the following Expressions (I), (II), and (III), each of a ratio of H (Z) to H (Y) (H (Z)/H (Y)) and a ratio of H (Z) to H (X) (H (Z)/H (X)), which are determined from the calculated H (Z), H (Y), and H (X), is 1.0 to 1.2,
H(Z)=(τs(Z)−τl(Z))/τl(Z) (I)
H(Y)=(τs(Y)−τl(Y))/τl(Y) (II)
H(X)=(τs(X)−τl(X))/τl(X) (III).

3. The antibacterial film according to claim 1,
wherein an arithmetic average roughness Ra of a surface of the antibacterial layer is 0.1 to 10 μm.

4. The antibacterial film according to claim 1,
wherein the average value Hc of the hazes of the antibacterial film in the wavelength range of 380 to 750 nm is 20% or more.

5. The antibacterial film according to claim 1,
wherein the light diffusing particle is an acrylic resin particle.

6. The antibacterial film according to claim 1,
wherein a content of the light diffusing particle is 1% to 15% by mass with respect to a total mass of the antibacterial layer.

7. The antibacterial film according to claim 1,
wherein the antibacterial agent particle contains silver.

8. The antibacterial film according to claim 1,
wherein the antibacterial agent particle contains a silver supporting carrier.

9. The antibacterial film according to claim 1,
wherein a content of the antibacterial agent particle is 0.1% to 20% by mass with respect to a total mass of the antibacterial layer.

10. The antibacterial film according to claim 1,
wherein a thickness of the antibacterial layer is 0.01 to 10 μm.

11. The antibacterial film according to claim 1,
wherein a material constituting the base material is at least one selected from the group consisting of polyethylene terephthalate, triacetyl cellulose, and polycarbonate.

12. The antibacterial film according to claim 1,
wherein an arithmetic average roughness Ra and a maximum height Rz of a surface of the base material satisfy both Expression (a1) and Expression (b1),
0.008 μm<Ra<0.015 μm (a1)
10<Rz/Ra<30 (b1).

13. The antibacterial film according to claim 1,
wherein the antibacterial layer is disposed on one surface of the base material, and
a pressure-sensitive adhesive layer is disposed on a surface of the base material opposite to the surface on which the antibacterial film is disposed.

14. A touch panel comprising the antibacterial film according to claim 1.

15. A manufacturing method for the antibacterial film according to claim 1, the manufacturing method comprising:
a step of applying a composition for forming an antibacterial layer, containing an antibacterial agent particle, a binder, and a light diffusing particle, onto a base material to form a coating film;
a step of heating the coating film at 20° C. to 60° C.; and
a step of curing the coating film to form an antibacterial layer by irradiating the coating film with an ultraviolet ray at an irradiation dose of 190 mJ/cm² or more.

16. The antibacterial film according to claim 2,
wherein an arithmetic average roughness Ra of a surface of the antibacterial layer is 0.1 to 10 μm.

17. The antibacterial film according to claim 2,
wherein the average value Hc of the hazes of the antibacterial film in the wavelength range of 380 to 750 nm is 20% or more.

18. The antibacterial film according to claim 2,
wherein the light diffusing particle is an acrylic resin particle.

19. The antibacterial film according to claim 2,
wherein a content of the light diffusing particle is 1% to 15% by mass with respect to a total mass of the antibacterial layer.

20. The antibacterial film according to claim 2,
wherein the antibacterial agent particle contains silver.
